(19) United States
(12) Patent Application Publication
(10) Pub. No.: US 2006/0158557 A1
(43) Pub. Date: Jul. 20, 2006

(54) METHOD AND APPARATUS FOR VIDEO PROCESSING

(76) Inventors: Shang-Chieh Wen, Tainan County (TW); Chien-Hsin Li, Tainan County (TW)

Correspondence Address: NORTH AMERICA INTELLECTUAL PROPERTY CORPORATION, P.O. BOX 506, MERRIFIELD, VA, 22116, US

(21) Appl. No.: 10/905,798

(22) Filed: Jan. 20, 2005

(51) Int. Cl. H04N 5/445; H04N 9/74

(52) U.S. Cl. 348/568; 348/581

(57) ABSTRACT

A method for video processing includes the steps of: receiving an image to generate a decimated image by discarding a plurality of pixels of the received image excluding those involved in arithmetic operations for scaling of the received image; and receiving the decimated image to derive a destination image by performing the arithmetic operations.

### BACKGROUND OF INVENTION

1. Field of the Invention

The present invention relates to video processing, and more particularly, to a method and apparatus for video processing with PIP/POP function.

2. Description of the Prior Art

Picture-in-picture/picture-outside-picture (PIP/POP) is a popular function for display devices having large dimensions, such as LCD TVs, PDP TVs etc. There are different modes of PIP/POP viewing, such as single PIP (SP), dual PIP (DP) and twin view/twin PIP. To fulfill the PIP/POP function, the display devices must include an apparatus for conversion of the dimension of images carried by a source video signal to one required by a specified PIP/POP viewing mode.

FIG. 1 shows a conventional apparatus for video processing with PIP/POP function. The apparatus 100 includes a scalar 110 and a frame buffer 120. A source video signal 108 carries data of source images having the same dimension. The scalar 110 receives the source video signal 108 and scales the source images for the specified PIP/POP viewing mode, which generates data of destination images carried by a destination video signal 112 sent to the frame buffer 120. The frame buffer 120 temporally stores and outputs on the signal 122 the data of the destination images to be transmitted to a display panel (not shown). Thus, the destination images are displayed as sub-pictures in the specified PIP/POP viewing mode.

However, the amount of the data of the destination images is more than that of the source images in some PIP/POP viewing mode where the expansion ratio in one direction is larger than the shrinkage ratio in the other direction. This necessitates a buffer having a large memory size and bandwidth. Therefore, the configuration of the conventional circuitry is not optimal.

### SUMMARY OF INVENTION

It is an objective of the present invention to provide a method for video processing and related apparatus.

According to an embodiment of the present invention, a method for video processing is disclosed. The method comprises the steps of: receiving an image to generate a decimated image by discarding a plurality of pixels of the received image excluding those involved in arithmetic operations for scaling of the received image; and receiving the decimated image to derive a destination image by performing the arithmetic operations.

According to an embodiment of the present invention, an apparatus for video processing is disclosed. The apparatus comprises: a decimation circuit receiving an image to generate a decimated image by discarding a plurality of pixels of the received image excluding those involved in arithmetic operations for scaling of the received image; and a scalar receiving the decimated image to derive a destination image by performing the arithmetic operations.

According to an embodiment of the present invention, an apparatus for receiving a source image to generate a destination image to be displayed as one of a plurality of sub-pictures in a PIP/POP viewing mode is disclosed. The apparatus comprises: a first scalar scaling the source image in a first direction to generate an intermediate image; a buffer temporally storing and then outputting the intermediate image; and a second scalar scaling in a second direction the intermediate image output from the buffer to generate the destination image.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 shows a conventional circuit for video with PIP/POP function.

FIG. 2 is a flowchart of a method for video processing with PIP/POP function according to one embodiment of the invention.

FIG. 3 shows a circuit for video processing with PIP/POP function according to one embodiment of the invention.

FIGS. 4-7 show layouts of the sub-pictures on the display panel in four different PIP/POP viewing modes according to one embodiment of the invention.

### DETAILED DESCRIPTION

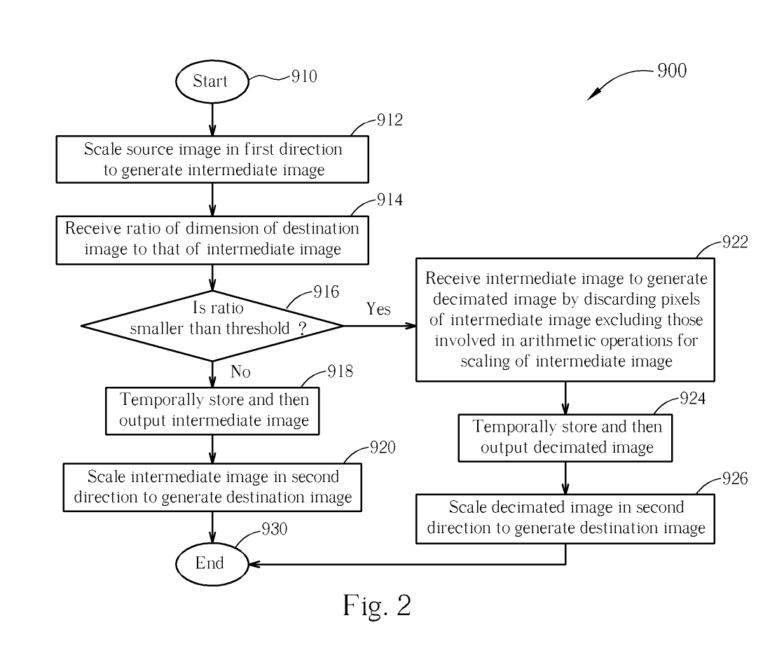

FIG. 2 is a flowchart of a method 900 for video processing with PIP/POP function according to one embodiment of the invention. Please note that the order of the steps shown in FIG. 2 is not a limitation of the present invention as long as the implementation of the present invention is not hindered. This embodiment can be described as follows. A source video signal carries data of source images. The source images are scaled in both horizontal and vertical direction by the method 900, which generates data of destination images transmitted to a display panel by a destination video signal. In this embodiment, the source images have a dimension of 720×480 and are scaled for a specified PIP/POP viewing mode requiring an image dimension of 360×160.

In Step 912, scale source images in a first direction to generate intermediate images. In this embodiment, the first direction is the horizontal direction of the source images. That is, in Step 912, horizontally scale the source images by a horizontal scaling factor, the ratio of the dimension required by the specified PIP/POP viewing mode to that of the source images in the horizontal direction. The horizontal scaling factor of this embodiment is ½ ( 360/720). Thus, an intermediate video signal output in Step 912 carries data of intermediate images having a dimension of 360×480.

In Step 914, receive a ratio of a dimension of the destination images to that of the intermediate images. Here the ratio corresponds to a second direction, which is the vertical direction of the source images in this embodiment. That is, in Step 914, receive the ratio of a horizontal dimension of the destination images to that of the intermediate images.

In Step 916, determine whether the ratio is smaller than a threshold. If the ratio is smaller than a threshold, enter Step 922; otherwise, enter Step 918.

For the scaling in the vertical direction, a combination of Steps 918-920 or a combination of Steps 922-926 is involved. Here the ratio is also referred to as a vertical scaling factor Y_SR, the ratio of the dimension required by the specified PIP/POP viewing mode to that of the source images in the vertical direction. In both combinations, scale each of the intermediate images by the vertical scaling factor Y_SR. The vertical scaling is achieved by arithmetic operations of pixels in scan lines of each intermediate image. More specifically, only a part of pixels (those in some specified scan lines) of each intermediate image is involved in the arithmetic operations if the vertical scaling factor Y_SR is smaller than the threshold, as shown by the arrow between Step 916 and Step 922. In this embodiment, the threshold is ½, the vertical scaling factor Y_SR is ⅓ ( 160/480) and the pixels in the n^{th} scan line of each destination image are derived by interpolations of the pixels in the (3n−1)^{th} and (3n−2)^{th} scan lines of a corresponding intermediate image, where n is a positive integer. Thus, only the pixels in the (3n−1)^{th} and (3n−2)^{th} scan lines of each intermediate image are involved in the arithmetic operations for the vertical scaling while the pixels in the (3n−3)^{th} scan lines are not involved.

In Step 922, receive the intermediate image to generate decimated images by discarding a plurality of pixels of the intermediate images excluding those involved in the arithmetic operations for vertical scaling of the intermediate images. In this embodiment, the pixels in the (3n−3)^{th} scan lines of each intermediate image are discarded in Step 922. Data of the decimated images is carried by a decimated video signal.

In Step 924, temporally store and then output the decimated images. In this embodiment, the decimated video signal is received and the data thereon, i.e. the data of the decimated images, is temporally stored and then output.

In Step 926, scale the decimated images in the second direction, which is the vertical direction, to generate the destination images. After executing Step 926, enter Step 930 to end. In this embodiment, the decimated images are received and each of the destination images is derived from performing the previously described arithmetic operations. In addition, since only the pixels in the (3n−1)^{th} and (3n−2)^{th} scan lines of the intermediate images remain in the decimated images, the pixels in each scan line of the destination images are generated by interpolations of the pixels in a corresponding pair of adjacent scan lines of the decimated images.

As mentioned above, the method 900 performs down-scaling in both horizontal and vertical direction. However, the method 900 may perform up-scaling in the horizontal or vertical direction. As shown by the arrow between Step 916 and Step 918, when the source images are up-scaled in the vertical direction or down-scaled by a vertical scaling factor larger than the threshold, all the pixels of the intermediate images are involved in the arithmetic operations and none of them is discarded in Steps 916-918, so each intermediate image and the decimated image thereof are the same. In Step 918, temporally store and then output the intermediate images, and in Step 920, scale the intermediate images in the second direction, which is the vertical direction, to generate the destination images. After executing Step 920, enter Step 930 to end.

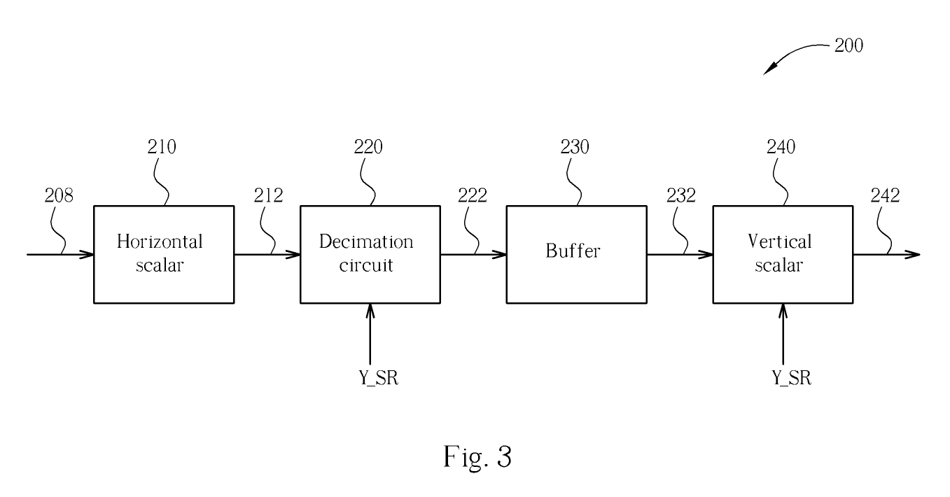

FIG. 3 shows an apparatus for video processing with PIP/POP function according to one embodiment of the invention. The apparatus 200 includes a horizontal scalar 210, a decimation circuit 220, a frame buffer 230, and a vertical scalar 240. Applying the aforementioned method 900 to the apparatus 200, the embodiment shown in FIG. 3 can be described as follows. A source video signal 208 carries data of the source images. The source images are scaled in both horizontal and vertical direction by the apparatus 200, which generates data of the destination images transmitted to a display panel by a destination video signal 242. In this embodiment, the source images have a dimension of 720×480 and are scaled for a specified PIP/POP viewing mode requiring an image dimension of 360×160.

For the scaling in the horizontal direction, the horizontal scalar 210 receives the source video signal 208 and horizontally scales the source images by a horizontal scaling factor, the ratio of the dimension required by the specified PIP/POP viewing mode to that of the source images in the horizontal direction. In this embodiment, the horizontal scaling factor is ½ ( 360/720). Thus, the intermediate video signal 212 output from the horizontal scalar 210 carries data of intermediate images having a dimension of 360×480.

For the scaling in the vertical direction, a combination of the decimation circuit 220, the frame buffer 230 and the vertical scalar 240 further vertically scales each of the intermediate images by a vertical scaling factor Y_SR, the ratio of the dimension required by the specified PIP/POP viewing mode to that of the source images in the vertical direction. The vertical scaling is achieved by arithmetic operations of pixels in scan lines of each intermediate image. More specifically, only a part of pixels (those in some specified scan lines) of each intermediate image is involved in the arithmetic operations if the vertical scaling factor Y_SR is smaller than a threshold, as shown by the arrow between Step 916 and Step 922. In this embodiment, the threshold is ½, the vertical scaling factor Y_SR is ⅓ ( 160/480) and the pixels in the n^{th} scan line of each destination image are derived by interpolations of the pixels in the (3n−1)^{th} and (3n−2)^{th} scan lines of a corresponding intermediate image, where n is a positive integer. Thus, only the pixels in the (3n−1)^{th} and (3n−2)^{th} scan lines of each intermediate image are involved in the arithmetic operations for the vertical scaling while the pixels in the (3n−3)^{th} scan lines are not involved.

The decimation circuit 220 receives the intermediate video signal 212 and the vertical scaling factor Y_SR, and discards some pixels of each intermediate image excluding those involved in the arithmetic operations for the vertical scaling when the vertical scaling factor Y_SR is smaller than the threshold. In this embodiment, the pixels in the (3n−3)^{th} scan lines of each intermediate image are discarded by the decimation circuit 220. Data of the decimated images is carried by the decimated video signal 222.

The frame buffer 230 receives the decimated video signal 222 and temporally stores the data of the decimated images to be sent to the vertical scalar 240 by the signal 232.

The vertical scalar 240 receives the decimated images and derives each of the destination images by performing the previously described arithmetic operations. In this embodiment, since only the pixels in the (3n−1)^{th} and (3n−2)^{th} scan lines of the intermediate images remain in the decimated images, the vertical scalar 240 generates the pixels in each scan line of the destination images by interpolations of the pixels in a corresponding pair of adjacent scan lines of the decimated images.

In the previously described embodiment, the apparatus 200 performs down-scaling in both horizontal and vertical direction. However, the apparatus 200 may perform up-scaling in the horizontal or vertical direction. As shown by the arrow between Step 916 and Step 918, when the source images are up-scaled in the vertical direction or down-scaled by a vertical scaling factor larger than the threshold, all the pixels of the intermediate images are involved in the arithmetic operations and none of them is discarded by the decimation circuit 220 so that each intermediate image and the decimated image thereof are the same.

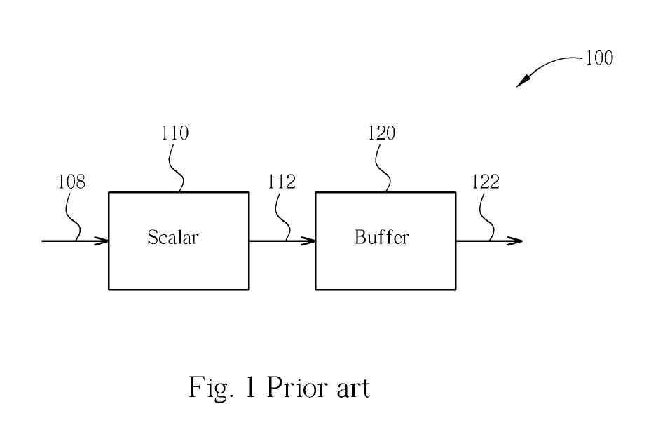

Additionally, it is noted that the frame buffer 230 is disposed between the horizontal and vertical scalars. This makes it possible that the amount of data stored in the buffer 230 is less than that in the buffer 120 shown in FIG. 1 when the vertical expansion ratio (the vertical scaling factor) is larger than the horizontal shrinkage ratio (the reciprocal of the horizontal scaling factor).

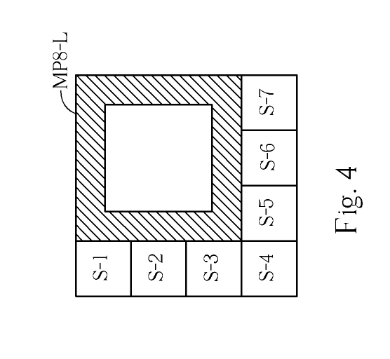

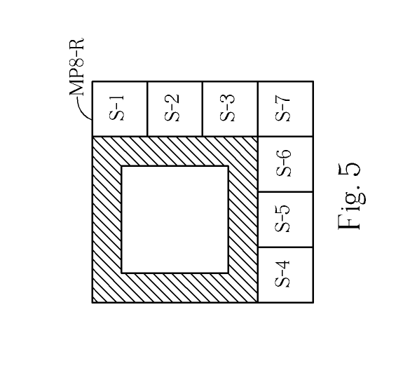

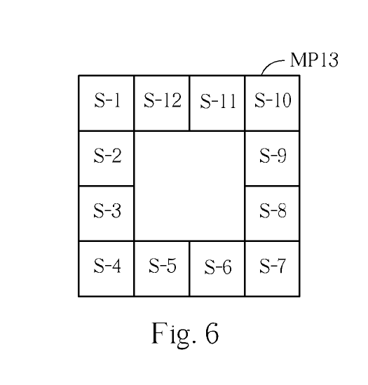

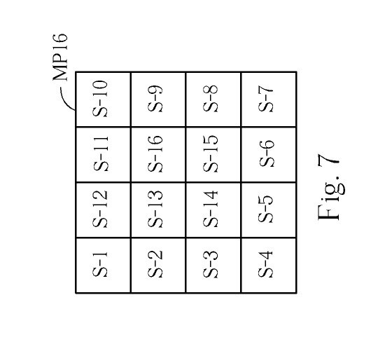

FIGS. 4-7 show layouts of the sub-pictures on the display panel in four different PIP/POP viewing modes according to one embodiment of the invention. These layouts result from an algorithm implementing by another circuit in the display device. FIG. 4 shows the sub-picture layout in the viewing mode MP8-L, wherein sub-pictures S-1, S-2, . . . , S-7 derived by the apparatus 200 shown in FIG. 3 are sequentially arranged from top-left to the bottom-right corner along the left and bottom edges of the display area, and a sub-picture S-8 is disposed in the remaining space. FIG. 5 shows the sub-picture layout in the viewing mode MP8-R, wherein the sub-pictures S-1, S-2, S-3 are sequentially arranged from top to bottom along the right edge of the display area, the sub-pictures S-4, S-5, S-6, S-7 are sequentially arranged from left to right along the bottom edge of the display area, and the sub-picture S-8 is disposed in the remaining space. FIG. 6 shows the sub-picture layout in the viewing mode MP13, wherein the sub-pictures S-1, S-2, . . . , S-12 are sequentially arranged along the four edges of the display area and the sub-picture S-13 is disposed in the center of the display area. FIG. 7 shows the sub-picture layout in the viewing mode MP16, wherein the sub-pictures S-1, S-2, . . . , S-16 are spirally arranged in a 4×4 array. It is noted that the sub-pictures in the layouts for the viewing modes MP8-L, MP13 and MP16 are actually disposed along spirals with different lengths.

The minimum memory size of the frame buffer 230 for a specified PIP/POP viewing mode depends on the number of the sub-pictures in that mode. For example, the size of the buffer 230 must be large enough to store at least 16 decimated images corresponding to 16 sub-pictures for the viewing mode MP16. Therefore, the size of the buffer 230 determines the variety of PIP/POP viewing mode in the display device. In this embodiment, the previously described spiral layouts have an advantage that the layout algorithm is applicable to display devices having different-sized frame buffers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for video processing, comprising:
a decimation circuit receiving an image to generate a decimated image by discarding a plurality of pixels of the received image excluding those involved in arithmetic operations for scaling of the received image; and
a scalar receiving the decimated image to derive a destination image by performing the arithmetic operations.

2. The apparatus as claimed in claim 1 further comprising:
a buffer temporally storing and then outputting the decimated image to the scalar.

3. The apparatus as claimed in claim 2, wherein the buffer is a frame buffer.

4. The apparatus as claimed in claim 1, wherein the decimation circuit further receives a ratio of a dimension of the destination image to that of the received image, and discards the pixels excluding those involved in the arithmetic operations only when the ratio is smaller than a threshold.

5. The apparatus as claimed in claim 4, wherein the threshold is ½.

6. The apparatus as claimed in claim 1 further comprising another scalar scaling a source image in a first direction to generate the received image, wherein the scaling of the received image is in a second direction.

7. The apparatus as claimed in claim 6, wherein the source image is scaled down in a horizontal direction and the received image is scaled in a vertical direction.

8. The apparatus as claimed in claim 6, wherein the destination image is displayed as one of a plurality of sub-pictures in a PIP/POP viewing mode.

9. The apparatus as claimed in claim 6, wherein the sub-pictures are spirally arranged in a display area.

10. The apparatus as claimed in claim 9, wherein the sub-pictures are sequentially arranged from a top-left to bottom-right corner along a left and bottom edges of the display area.

11. The apparatus as claimed in claim 9, wherein the sub-pictures are sequentially arranged along all the edges of the display area.

12. The apparatus as claimed in claim 6, wherein a part of the sub-pictures are sequentially arranged from top to bottom along a right edge of a display area while the other part of the sub-picture are sequentially arranged from left to right along a bottom edge of the display area.

13. An apparatus for receiving a source image to generate a destination image to be displayed as one of a plurality of sub-pictures in a PIP/POP viewing mode, the apparatus comprising:
a first scalar scaling the source image in a first direction to generate an intermediate image;
a buffer temporally storing and then outputting the intermediate image; and
a second scalar scaling in a second direction the intermediate image output from the buffer to generate the destination image.

14. The apparatus as claimed in claim 13, wherein the buffer is a frame buffer.

15. The apparatus as claimed in claim 13, wherein the source image is scaled down in a horizontal direction and the intermediate image is scaled in a vertical direction.

16. The apparatus as claimed in claim 13, wherein the sub-pictures are spirally arranged in a display area.

17. The apparatus as claimed in claim 16, wherein the sub-pictures are sequentially arranged from a top-left to bottom-right corner along a left and bottom edges of the display area.

18. The apparatus as claimed in claim 16, wherein the sub-pictures are sequentially arranged along all the edges of the display area.

19. The apparatus as claimed in claim 13, wherein a part of the sub-pictures are sequentially arranged from top to bottom along a right edge of a display area while the other part of the sub-picture are sequentially arranged from left to right along a bottom edge of the display area.

20. A method for video processing comprising the steps of:
receiving an image to generate a decimated image by discarding a plurality of pixels of the received image excluding those involved in arithmetic operations for scaling of the received image; and
receiving the decimated image to derive a destination image by performing the arithmetic operations.

21. The method as claimed in claim 20, wherein the pixels excluding those involved in the arithmetic operations are discarded only when a ratio of a dimension of the destination image to that of the received image is smaller than a threshold.

22. The method as claimed in claim 20, wherein the destination image is displayed as one of a plurality of sub-pictures in a PIP/POP viewing mode.
